(19) United States
(12) Patent Application Publication
(10) Pub. No.: US 2019/0026842 A1
(43) Pub. Date: Jan. 24, 2019

(54) SYSTEM FOR IDENTIFYING COMPATIBLE INDIVIDUALS IN A DESIGNATED LOCATION

(71) Applicant: Charles E. Glass, Guilford, CT (US)

(72) Inventor: Charles E. Glass, Guilford, CT (US)

(21) Appl. No.: 16/041,289

(22) Filed: Jul. 20, 2018

Related U.S. Application Data
(60) Provisional application No. 62/535,583, filed on Jul. 21, 2017.

(51) Int. Cl. G06Q 50/00; H04L 29/08; H04L 12/58; H04W 4/021; G06F 17/30

(52) U.S. Cl. CPC G06Q 50/01; H04L 67/306; G06F 17/30867; H04W 4/021; H04L 51/32

(57) ABSTRACT

A system configured to connect users based on shared characteristics is disclosed. Each user has a profile including one or more profile tag matching preferences and at least one profile tag. The location of the system users are monitored, which allows the system to determine when system users are coming into proximity with each other. The system analyzes a user-defined location for the presence of other system users. If other system users are present in the user-defined location, the system compares the user's profile tags and profile tag matching preferences to those of the other system users in the user-defined location to determine if any two or more system users are a match. When the system determines that any two or more system users in a user-defined area are a match, the user is alerted of the match.

### CROSS REFERENCE TO RELATED APPLICATION(S)

This application claims the benefit of U.S. Provisional Patent Application No. 62/535,583, filed Jul. 21, 2017, which is incorporated by reference as if disclosed herein in its entirety.

### BACKGROUND

With the growth of social media over the last decade, individuals have had never-before-seen abilities to interact and maintain contact with the world around them. Social networks easily expanded from those in close proximity to across the globe without significant increases in the complexity or hassle of communication between acquaintances.

However, current social networks rely on a network of known friends and/or contacts. Members of a social network are essentially required to at least be acquainted with each other before it is possible to actually utilize the social network to coordinate a meeting between those members. As a result, connections between persons in the same geographic area with substantial commonalities are missed every day simply because no common acquaintance was present to identify the connection possibility. How does one know whether a former college classmate or someone from your hometown is in your immediate vicinity, whether that be at the theater, on top of Mt. Washington, or just down the block?

### SUMMARY

Some embodiments of the present disclosure include a system configured to connect users based on shared characteristics. In some embodiments, each user has a profile including profile tag matching preferences and at least one profile tag. In some embodiments, the location of the system users are monitored, which allows the system to determine when system users are coming into proximity with each other. In some embodiments, user location is determined via GPS.

In some embodiments, the system analyzes a user-defined location for the presence of other system users. If other system users are present in the user-defined location, the system compares the user's profile tags and profile tag matching preferences to those of the other system users in the user-defined location to determine if any two or more system users are a match. In some embodiments, if the system determines that any two or more system users in a user-defined area are a match, the user is alerted of the match. In some embodiments, the system also includes a messaging function to allow system users to communicate with each other.

### BRIEF DESCRIPTION OF THE DRAWINGS

The drawings described herein are for illustration purposes only and are not intended to limit the scope of the present disclosure in any way.

FIG. 1 is a schematic diagram of a system for identifying a match between system users according to some embodiments of the present disclosure;

FIG. 2A is an image of system for identifying a match between system users in use according to some embodiments of the present disclosure;

FIG. 2B is an image of system for identifying a match between system users in use according to some embodiments of the present disclosure;

FIG. 2C is an image of system for identifying a match between system users in use according to some embodiments of the present disclosure; and

FIG. 2D is an image of system for identifying a match between system users in use according to some embodiments of the present disclosure.

### DESCRIPTION

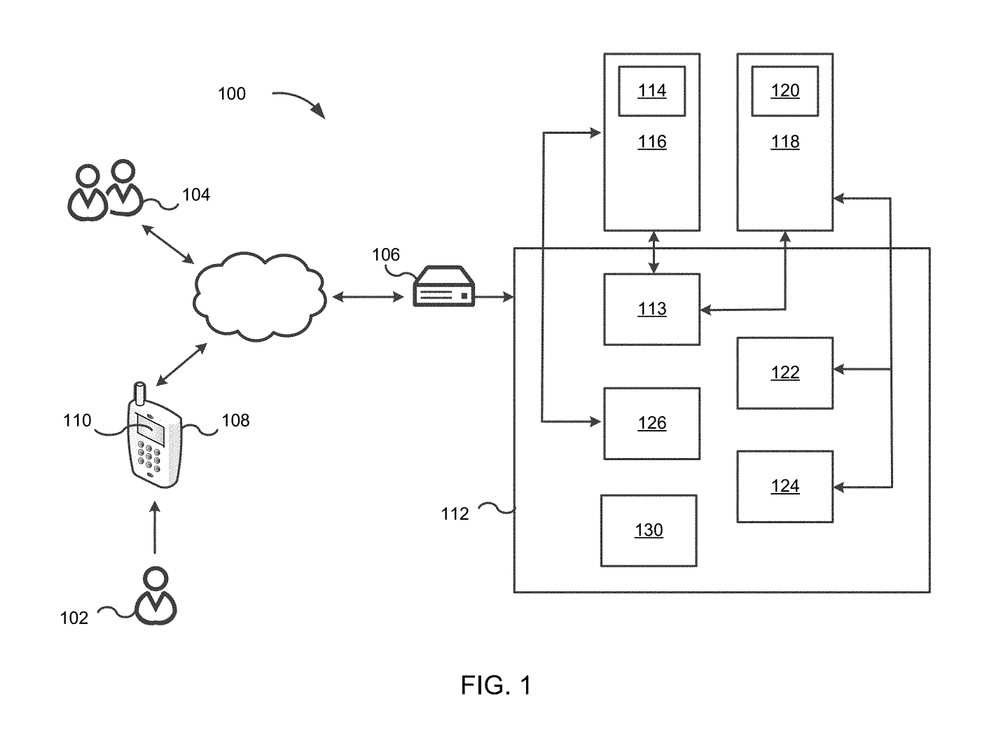

Referring now to FIG. 1, some embodiments of the disclosed subject matter include a system 100 for identifying a match between a user 102 and other system users 104 and then informing user 102 of that match. In some embodiments, system 100 is computer-implemented, including a non-transitory computer storage medium 106 in communication with a user computing device 108 for displaying system related information to user 102 via a graphic user interface 110. In some embodiments, computing device 108 communicates with other system users 104 and/or computer storage medium 106 via the cloud/internet. In some embodiments, electronic computing device 108 is a laptop, desktop, mobile phone, tablet computer, PDA, etc. Computer storage medium 106 is encoded with one or more computer programs 112 and configured to execute those programs to perform the functions of system 100 as described herein. In some embodiments, computer programs 112 include a series of modules.

In some embodiments, system 100 includes a profile module 113. Each system user has a profile 114. In some embodiments, profile module 113 is configured to create and edit profiles 114, such as by adding, editing, or deleting information included therein. In some embodiments, profiles 114 include user location information, associated profile tags, and profile tag matching preferences. In some embodiments, profiles 114 also include bibliographic information, a profile image, profile audio, user connections, user connection history, privacy preferences, general user preferences, or combinations thereof. Profile tag matching preferences include criteria by which system 100 will match user 102 with another system user 104, as will be discussed in greater detail below. In some embodiments, profile 114 is stored locally on computing device 108. In some embodiments, system 100 includes a user profile database 116. In some embodiments, user profile database 116 includes all profiles 114 for system users. In some embodiments, user profile database 116 is stored locally on computer storage medium 106. In some embodiments, user profile database 116 is stored remotely from computer storage medium 106.

In some embodiments, system 100 includes a profile tag database 118 including profile tags 120 known by the system. Profile tags 120 are identifying words that system users associate with their profiles 114, such as those consistent with their background and interests. By associating profile tags 120 with a profile 114, the profile becomes a personal representation of user 102 as they would like to be identified by other users 104. In some embodiments, user 102 may only associate a limited number of profile tags 120 with a profile 114. In some embodiments, user 102 may associate any number of profile tags 120 with a profile 114. A match is a pair of system users whose profile tags 120 and profile tag matching preferences align for a given user-defined location, as will be discussed below. In some embodiments, profile tags 120 are predefined by system 100. In some embodiments, system users create new profile tags 120 if a satisfactory one is not found in profile tag database 118. In some embodiments, profile tags 120 created by user 102 are stored in profile tag database 118 and become available for use by other system users 104 once created. In some embodiments, system 100 includes a profile tag searching module 122. In some embodiments, when user 102 desires to add a new characteristic to profile 114, profile tag searching module 122 reviews profile tag database 118 for profile tags that fit are relevant to that characteristic. In some embodiments, system 100 includes a profile tag maintenance module 124 to identify duplicate or redundant profile tags 120 and merge all system users associated with the duplicate profile tags to a single profile tag representative of the duplicate profile tags. In some embodiments, system 100 learns those profile tags 120 in profile tag database 118, predicts a user-desired profile tag 120 as user 102 is entering it into profile 114, and suggests to the user profile tags already included in the profile tag database. In some embodiments, system 100 learns those profile tags 120 in profile tag database 118, predicts a user desired profile tag 120 as user 102 is entering it into profile 114, and suggests to the user synonymous profile tags already included in the profile tag database. In some embodiments, profile tag database 118 is stored locally on computer storage medium 106. In some embodiments, profile tag database 118 is stored remotely from computer storage medium 106. In some embodiments, the addition, editing, and removal of profile tags 120 in profiles 114 is performed via profile module 113.

In some embodiments, system 100 determines the location of system users. In some embodiments, the locations of system users are determined in real-time. In some embodiments, user location is determined via the location services on the user's personal electronic device 108, GPS, near-field communication, connected Wi-Fi networks, etc.

In some embodiments, system 100 includes a matching module 126. Matching module 126 is configured to review a user's profile 114 and user-defined location, and the locations and profiles of other system users 104 to identify for user 102 any other system users that “match”. As discussed above, another system user 104 is a match for user 102 if profile tags 120 and profile tag matching preferences for those users are in alignment, and if other system user 104 is within the user-defined location. In some embodiments, the user-defined location is set manually by user 102. For example, a user 102 traveling to New York City may select that city as the user-defined location prior to arriving to help the user determine which neighborhoods and/or places of interest may be worth a visit. In some embodiments, the user-defined location is set automatically by system 100. In some embodiments, system 100 uses the geolocation of user 102, e.g., via the location services on the user's personal electronic device, GPS, etc., connected Wi-Fi networks, etc., and defines a user-defined location around that user. In some embodiments, the radius of the user-defined area is variable from the smallest possible via GPS to 1, 2, 5, 10, or more miles. In some embodiments, the user-defined location is a venue, an event (e.g., a concert, play, sporting event, wedding, etc.), trip (e.g., a flight, cruise, etc.), neighborhood, city, state, region (e.g., New England, USA, Pacific Northwest, USA, etc.), user-defined geo-fenced area, etc. Matching module 126 is also configured to display matches based on this criteria to user 102 via a graphic user interface 110, as will be discussed in greater detail below. In some embodiments, user 102 and other system user 104 are informed when a match is identified between them.

As discussed above, matching module 126 determines matches between user 102 and other system users 104 at least in part based on profile tag matching preferences. Profile tag matching preferences help system 100 better curate the matches displayed to user 102. In some embodiments, system 100 matches users 102 with other system users 104 who share any one profile tag. In some embodiments, system 100 matches users with other system users only when they share a certain specific tag. In some embodiments, system 100 matches users with other system users only when they share a plurality of profile tags. In some embodiments, system 100 matches users with other system users only when they share a certain specific profile tag and at least one additional profile tag. In some embodiments, system 100 matches users with other system users only when they share a certain specific profile tag and a plurality of other profile tags. In some embodiments, system 100 matches users with other system users only when they share a plurality of certain specific profile tags. In some embodiments, system 100 matches users with other system users only when they share a plurality of certain specific profile tags and at least one additional profile tag. In some embodiments, system 100 matches users with other system users only when they share a plurality of certain specific profile tags and a plurality of other profile tags. For example, user may define that another user must be a fan of the same baseball team, and also must share at least one of the same hometown, gone to the same college, or work in graphic design for there to be a match between the users. In some embodiments, system 100 matches users with other system users only when they share all profile tags in their profiles. In some embodiments, profile tags may be grouped together in profile tag groups. In some embodiments, profile tag matching preferences include intra-group preferences and/or inter-group preferences. For example, a user profile tag matching preference may require at least two profile tags from a first group of profile tags, at least one profile tag from a second group of profile tags, and at least one profile tag from a third group of profile tags for there to be a match between the users. Those skilled in the art would understand the examples above of valid “matches” between system users were by way of example only, and that other logic schemes may be used by user 102 to ensure that matches returned by matching module are as broad or specific as the user desires. In some embodiments, profile tags 120 associated with a user profile 118 can be turned “on” and “off”, i.e., user 102 can temporarily remove or activate profile tags on a case by case basis without completely disassociating and reassociating the profile tags from their profile each time.

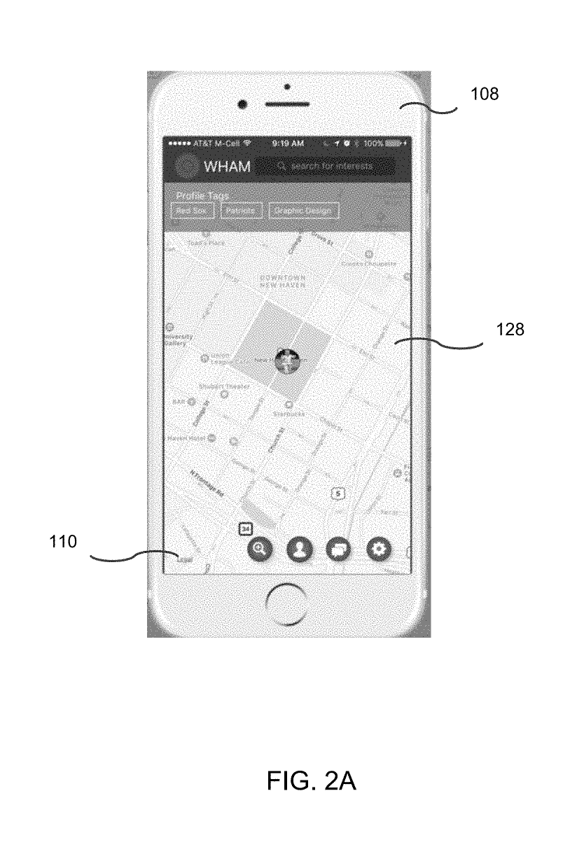

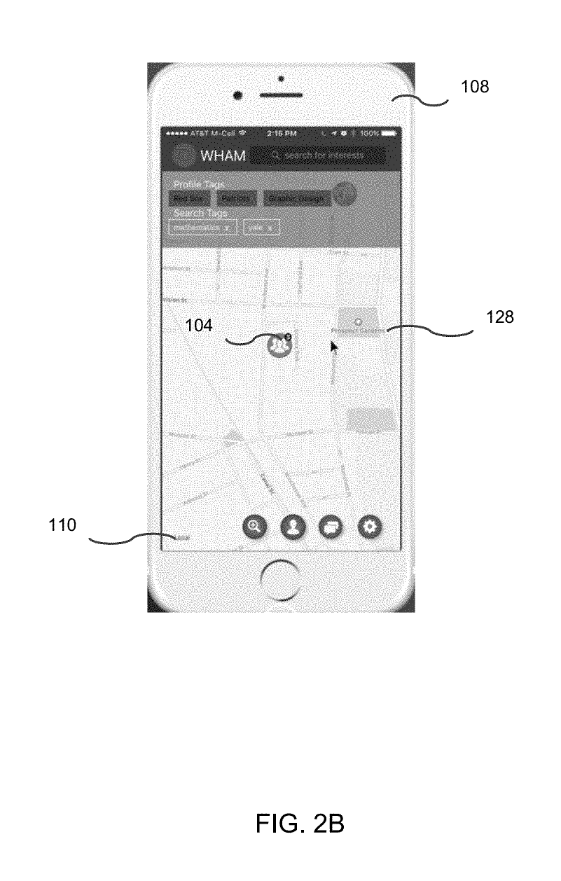

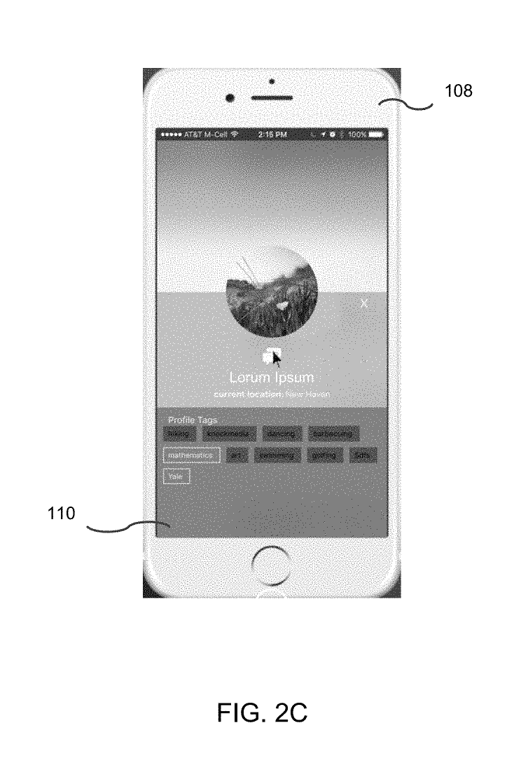

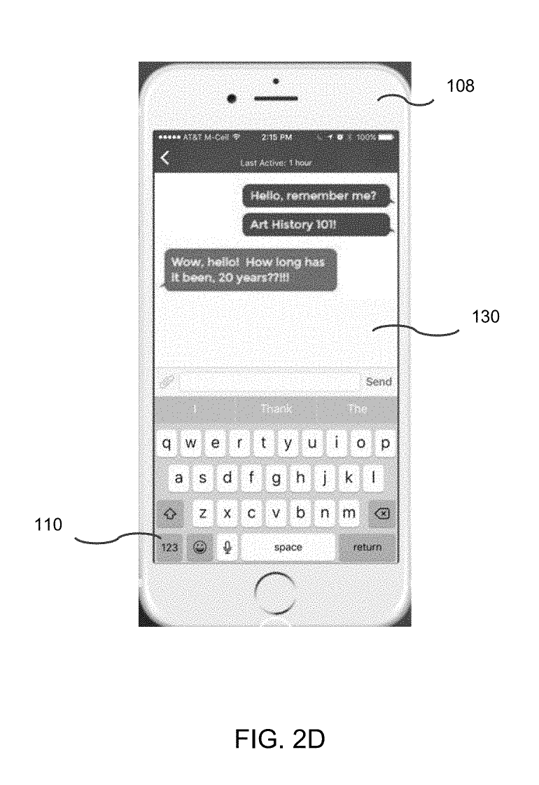

Referring now to FIG. 2A, as discussed above, in some embodiments, system 100 includes a graphic user interface 110 enabling user 102 to interact with the system via electronic computing device 108. In some embodiments, other system users 104 identified by matching module 126 are displayed to user 102 via graphic user interface 110. In some embodiments, graphic user interface 110 includes a map interface 128 for displaying the user-defined location to user 102. Information relevant to the user-defined location is identified on map interface 128. For example, map interface 128 may show the streets, street names, places of interest within the user-defined location, etc. Referring now to FIG. 2B, in some embodiments, the locations of other system users 104 identified by matching module 126 are displayed on map interface 128. In some embodiments, the user-defined location may be changed by zooming into or out of map interface 128. In some embodiments, graphic user interface 110 highlights those profile tags 120 which are shared between two user profiles 114. Referring now to FIG. 2C, in some embodiments, profiles 114 for other system users 104 identified by matching module 126 are viewable via graphic user interface 110. In some embodiments, other system user 104 needs to authorize a match for their profile 114 to become visible to user 102.

Referring now to FIG. 2D, in some embodiments, system 100 includes a messaging module 130. In some embodiments, messaging module 130 enables user 102 to message with other system users 104. In some embodiments, messaging module 130 enables sending of messages via SMS, MMS, etc. In some embodiments, messaging module 130 enables group messaging between two or more users.

The systems and methods of the present disclosure are advantageous in that they enable connections between individuals without the need for an intermediary. The profile tags and profile tag matching preferences act to screen other system users so that the user can be confident that any matches from the system will have a high likelihood of success. Further, profiles may be set up in advance, so users need only utilize the location determination services identified above to find matches. Finally, user-defined locations enable advanced planning by helping users identify locations with other individuals who share certain desired characteristics without physically visiting those locations. For example, users in a new city hoping to watch their favorite sports team with other fans of that team would be able to identify establishments with the greatest numbers and highest concentrations of kindred fans prior to leaving their hotel, without falling victim to ill-informed locals or irregular crowd-composition.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

1. A system for matching a user with another system user comprising:
database of profile tags;
database of user profiles, said user profile including user location information, at least one profile tag, and a profile tag matching preference;
a graphic user interface displayed on a computing device; and
a non-transitory computer storage media coupled with said computing device and encoded with one or more computer programs for matching said user with said another system user, the one or more computer programs including:
a profile module configured to create profiles for storage in said profile database and edit profiles in said profile database;
a matching module configured to identify a match between said user and said another system user at a user-defined location based on said profile tags and said profile tag matching preferences for said user and communicate said match to said user via said graphic user interface;
a messaging module configured to enable messaging between said user and said another system user;
software configured to identify the location of system users;
software configured to define said user-defined location;
software configured to learn those profile tags in said profile tag database, predict a user desired profile tag as said user is editing their profile to include said desired profile tag, and suggest to said user profile tags already included in said profile tag database; and
software configured to learn those profile tags in said profile tag database, predict a user desired profile tag as said user is editing their profile to include said desired profile tag, and suggest to said user synonymous profile tags already included in said profile tag database.

2. The system according to claim 1, wherein said profiles further include bibliographic information, a profile image, profile audio, user connections, user connection history, privacy preferences, general user preferences, or combinations thereof.

3. The system according to claim 1, further comprising:
a profile tag searching module configured to review said profile tag database for profile tags that match a user search; and
a profile tag maintenance module configured to identify duplicate or redundant profile tags and merge all system users associated with the duplicate profile tags to a single profile tag representative of the duplicate profile tags.
